(19) United States
(12) Patent Application Publication
(10) Pub. No.: US 2006/0096340 A1
(43) Pub. Date: May 11, 2006

(54) Theft-prevention device for parking a two-wheeled vehicle

(76) Inventors: Alain Laquieze, Besse (FR); Larissa Choulova, Kazan (RU)

Correspondence Address: John S. Egbert;Egbert Law Offices, 7th Floor, 412 Main Street, Houston, TX, 77002, US

(21) Appl. No.: 11/265,626

(22) Filed: Nov. 2, 2005

(30) Foreign Application Priority Data
Nov. 8, 2004 (FR) 04 52557

(51) Int. Cl. B60R 25/00

(52) U.S. Cl. 70/225

(57) ABSTRACT

Theft-prevention device for parking a two-wheeled vehicle includes, on the one hand, an accommodating device for one of the wheels of the vehicle. Extending on both sides and eventually above the wheel, in order to wrap more than half of the wheel, so as to make the hub thereof inaccessible. On the other hand, inside the accommodating device, there are seizing elements of the wheel through hooking-in.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates to a theft-prevention device for parking a two-wheeled vehicle.

### BACKGROUND OF THE INVENTION

Traditionally, the parking of the two-wheeled vehicles, whether motorized or not, occurs either through its own means, such as standing legs, or through structures allowing it to rest through jamming a wheel, for example, while the theft-prevention function is ensured by a chain or the like closed by means such as a padlock-type closing device.

The means used have the drawback of being not very effective. Indeed, a two-wheeled vehicle not firmly connected to a structure can easily be removed without having to be concerned about its theft-prevention system which can be removed later on, and if it is fixed to a structure through a wheel, it can be easy to dismount said wheel and to remove the rest of the vehicle, or, depending on the equipment used by the thief, to cut the theft-prevention system.

In addition, for most of the current devices, there remains the risk that the vehicles might fall, which can cause, in addition to damage to said vehicles, injuries to people passing by.

In order to cope with these drawbacks, various devices for allowing a secure parking of the two-wheeled vehicles have been provided. The most effective ones are those which are in the form of a locker closed by means of a door provided with a lock and which is capable of containing a vehicle. These devices, such as those described for example in FR 2,762,343 and FR 2,764,261, have the drawback, in addition to a large size, of being unaesthetic.

Others have provided devices allowing seizing the two-wheeled vehicle by a part other than a wheel, and in particular by the frame, such as for example the one described in WO 97/30884. Such a device is however limited to be used only with a determined form of two-wheeled vehicle and, in particular, bicycles the frame of which has a determined architecture and namely a horizontal bar.

Others have provided, as in CH 683 248, a theft-prevention device comprising, on the one hand, accommodating means capable of accommodating the front wheel of a bicycle and, on the other hand, integral with said accommodating means, coupling means, such as a chain or cable, allowing enclosing another part of said bicycle. In addition to the size of such a device, the coupling means are of a classical type and can be forced in the same way.

From JP 2004 001657 is also known a theft-prevention device allowing to grip the wheel of a bicycle; though it allows immobilization of a wheel, it cannot prevent separating the rest of the bicycle from the latter.

### BRIEF SUMMARY OF THE INVENTION

This invention is aimed at providing a theft-prevention device for parking a two-wheeled vehicle, allowing to cope with the various above-mentioned drawbacks.

The theft-prevention device for parking a two-wheeled vehicle according to the invention is primarily characterized in that it comprises, on the one hand, accommodating means capable of accommodating one of the wheels of said vehicle by extending on both sides, in order to wrap more than half of it, so as to make its hub inaccessible; and, on the other hand, internally to said accommodating means, means capable of seizing, through hooking-in, said wheel and/or part of the frame of said vehicle.

According to an additional feature of the device according to the invention, the means for seizing through hooking-in is associated with a stop means arranged inside the means for accommodating said wheel, which is capable of being pushed back by said wheel during the insertion of the latter into said accommodating means, and the displacement of which under the thrust of said wheel is capable of triggering the operation of said seizing means.

According to another additional feature of the device according to the invention, the stop means is provided with a toothed rack and blocking catch system, associated with unlocking means, which it co-operates with during its displacement under the thrust of the wheel.

According to another additional feature of the device according to the invention, the unlocking means is associated with a coin-slot device and/or coding means.

According to another additional feature of the device according to the invention, the means for seizing through hooking-in comprises at least one moving part capable of being moved transversely with respect to the wheel of the vehicle, so as to pass through it between the rim and the hub.

According to another additional feature of the device according to the invention, it comprises means allowing prevention of the vehicle from being lifted.

The means for seizing through hooking-in can be this means, according to its position in the device, and thus the location where the hooking-in has to occur.

According to another additional feature of the device according to the invention, the means capable of accommodating the wheel consist of two substantially vertical and parallel walls, between which is provided for a space allowing the insertion of said wheel, while a horizontal wall extends above said space and connects said two walls.

According to a particular embodiment of the device according to the invention, the means for seizing through hooking-in consists of a chuck jaw the two jaws of which are capable of closing around the rim of the wheel.

According to another particular embodiment of the device according to the invention, the means for seizing through hooking-in consists of a hook capable of unfolding in order to pass through the wheel, preferably between elements of the frame.

According to a particular embodiment of the device according to the invention, the means capable of accommodating the wheel consist of two substantially vertical and parallel walls, between which is provided for a space allowing the insertion of said wheel, and at least part of which is mobile in displacement to come close to or to separate from each other, so as to adapt the width of said space to the thickness of said wheel.

The advantages and features of the device according to the invention will become clear from the following description, which refers to the attached drawing, which represents several non-restrictive embodiments of it.

### BRIEF DESCRIPTION OF THE SEVERAL VIEWS OF THE DRAWINGS

FIG. 1 shows a schematic side and cross-sectional view of a theft-prevention device according to the invention, before use.

FIG. 2 shows a schematic side and cross-sectional view of the same device, during use.

FIG. 3 shows a schematic and cross-sectional view of the device as shown in FIG. 1.

FIG. 4 shows a schematic and cross-sectional view of the device as shown in FIG. 2.

FIG. 5 shows a partial schematic side view of another embodiment of the theft-prevention device according to the invention.

FIG. 6 shows a schematic front view of the same device.

### DETAILED DESCRIPTION OF THE INVENTION

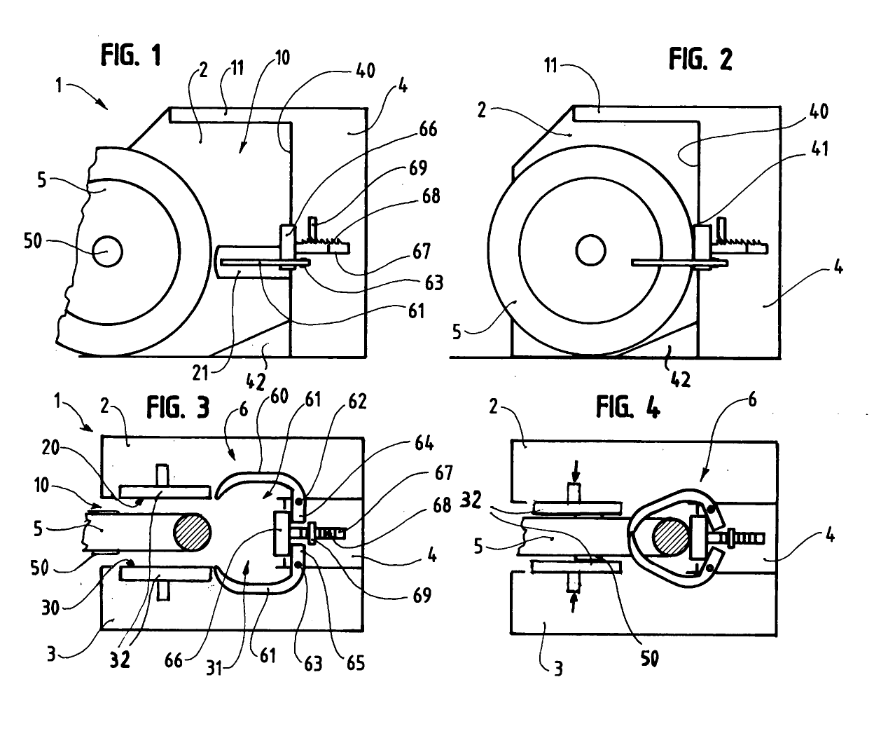

When referring to FIGS. 1, 2, 3 and 4, one can see a theft-prevention device 1 for parking a two-wheeled vehicle according to the invention.

This device 1 is in the form of a structure primarily comprising two parallel vertical cases 2 and 3 connected by a rear case 4, and defining a central space 10 of a width allowing insertion of a wheel 5 of the two-wheeled vehicle.

The dimensions of the cases 2, 3 and 4 and, in particular, those of their inner walls 20, 30 and 40, respectively, which define the space 10, are chosen so that the wheel 5 can be accommodated in this space 10 beyond its hub 50, so that the latter is hidden in it and cannot be reached to fraudulently dismount the wheel 5. To this end, the width of the space 10 must be just sufficient for the passing through of this wheel 5.

It should be noted that the theft-prevention device 1 as shown also includes an upper wall 11, which extends above the space 10 and which connects the two cases 2 and 3. This wall 11 allows increasing the inaccessibility to the wheel 5.

The theft-prevention device 1 is provided with a mechanism for seizing through hooking-in the wheel 5, which, in this embodiment is in the form of a chuck jaw 6 comprising two jaws 60 and 61 articulated at the level of the case 4 and capable of being extracted from the cases 2 and 3, respectively, while passing through openings 21 and 31, respectively, provided for in the walls 20 and 30, respectively, in order to be closed in the space 10.

In the embodiment shown, the jaws 60 and 61 are independent, each being mounted so as to freely pivot about a vertical axis 62 and 63, respectively, the inactive parts 64 and 65, respectively, of the jaws 60 and 61 extending between these axes 62 and 63.

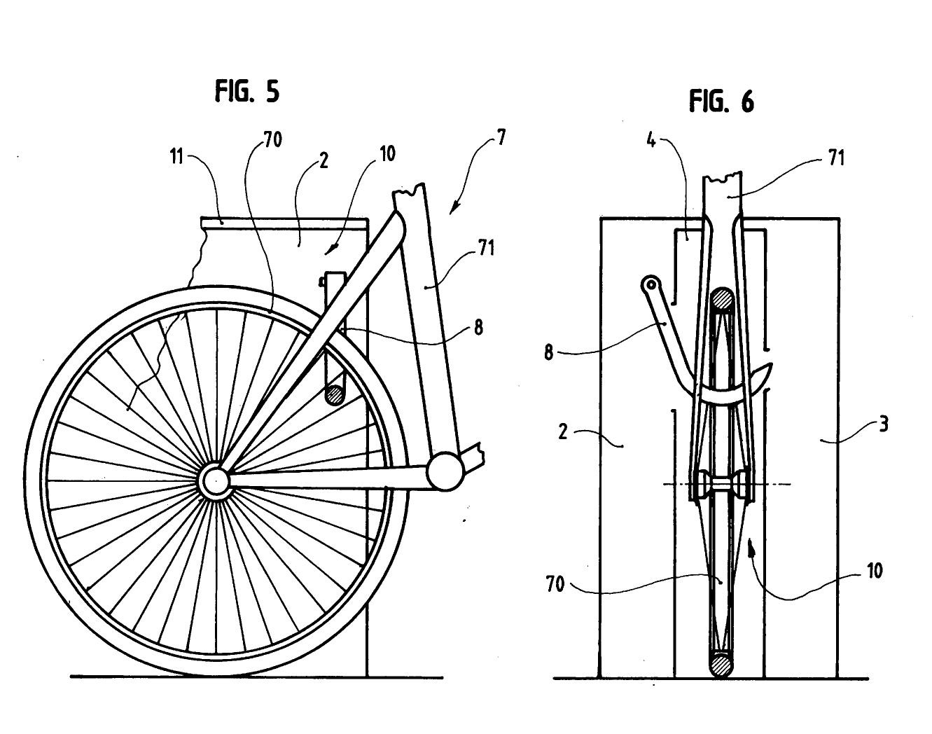

As can be seen more clearly in FIGS. 2 and 4, the mechanism also comprises a system for triggering the closing of the jaws 60 and 61. This triggering system comprises a stop 66 integral with the end of a slide 67, movable in horizontal translation and which passes through the wall 40 of the case 4, through an opening 41. The stop 66, which, at rest, i.e. when the theft-prevention device 1 is not used, protrudes into the space 10, can be pushed back into the case 4 by the wheel 5 during the insertion of the latter into the space 10. When the stop 66 enters into the case 4, it causes the jaws 60 and 61 to pivot into closed position by resting on the inactive parts 64 and 65.

The slide 67 is, furthermore, provided with a toothed rack 68 which co-operates with a catch 69 allowing blocking it when it is in re-entered position, and thus to immobilize the jaws in closed position. The catch 69 is associated with unlocking means, not shown, which is itself associated with a coin-slot device and/or coding means.

The theft-prevention device according to the invention thus allows immobilizing a wheel of a two-wheeled vehicle, while preventing this wheel from being dismounted.

It should be noted that the embodiment of the device according to the invention shown in FIGS. 1, 2, 3 and 4 is more particularly intended for parking motorized two-wheeled vehicles, such as the scooters, motor-bikes and the like.

One should note the presence at the foot of the wall 40, of an inclined plane 42 onto which can roll and raise the small-diameter wheels, so as to facilitate their access to the chuck jaw 6.

It should also be noted that, advantageously, from the point of view of the construction, it is contemplated that the seizing mechanism assembly constitutes a block that can be separated from the device, in order to allow its removal and its replacement by another one for maintenance purposes.

In this embodiment, each wall 30 consists of the inner face of a plate 31 movable in displacement so as to allow varying the width of the space 10 and its adaptation to the thickness of the wheel 5.

These plates 32 can be driven, for example, by jacks, not shown, and controlled by the displacement of the stop 66. These plates 32 can thus enter into contact with the hub 50, preferably without exerting any pressure on the latter, by using for example pressure sensors which allow controlling the stoppage of displacement and the maintaining in position.

It should be noted that the plates 32 can preferably have a concave form, so as to favor a covering of the hub 50.

The plates 32 are thus brought as close as possible to the hub 50, irrespective of the size and the nature of the latter. It is thus possible to contemplate an initial space 10 of a large width, in order to be able to accommodate both bicycles and scooters, and even motor-bikes.

Furthermore, because of this possibility of narrowing the space 10 as much as required, it is possible to contemplate to omit a horizontal wall 11, thus making the entire theft-prevention device more compact.

When referring now to FIGS. 5 and 6, one can see another embodiment of the device according to the invention, in particular for parking a bicycle 7.

As can be seen in FIG. 6, the device also comprises three cases 2, 3 and 4 which define, with an upper wall 11, a space 10 aimed at receiving the wheel 70 of the bicycle 7, which is preferably the rear wheel.

The mechanism for seizing the wheel 70 through hooking-in comprises a hook 8 capable of being unfolded in the space 10 while passing through the wall 20, in order to be blocked at the level of the wall 30, after having passed through the wheel 70, preferably between elements of the frame 71.

The unfolding of the hook 8 can be occur through means, not shown, similar to the one used in the first embodiment, i.e. a thrust member against which the wheel 70 is aimed at resting in order to cause, through bending means, the hook 8 to swivel.

The device can, furthermore, include accessories such as for example a cabinet for placing objects such as the user's helmet or gloves, the locking of this cabinet occurring at the same time as the actuation of the theft-prevention device.

We claim:

1. Theft-prevention device for parking a two-wheeled vehicle, comprising:
means for accommodating one wheel of the vehicle, extending on both sides and above said wheel, in order to wrap more than half of said wheel, a hub thereof being inaccessible; and
means for seizing located internally to said accommodating means, through hooking-in said wheel and/or part of a frame of said vehicle.

2. Theft-prevention device according to claim 1, wherein said means for seizing is associated with a stop means arranged inside the means for accommodating said wheel, said stop means being pushed back by said wheel during the insertion of the stop means into the accommodating means, displacement of the accommodating means under thrust of said wheel triggering operation of the seizing means.

3. Theft-prevention device according to claim 2, wherein said stop means is comprised of a toothed rack and blocking catch system associated with an unlocking means, cooperating therewith during displacement under the thrust of the wheel.

4. Theft-prevention device according to claim 3, further comprising:
an unlocking means associated with a coin-slot device and/or coding means.

5. Theft-prevention device according to claim 1, wherein the means for seizing through hooking-in comprises at least a moving part, moved transversely with respect to the wheel of the vehicle, so as to pass through wheel between the rim and the hub.

6. Theft-prevention device according to claim 1, further comprising:
means to prevent the vehicle from being lifted.

7. Theft-prevention device according to claim 1, wherein the means for accommodating the wheel is comprised of two substantially vertical and parallel walls, a space between the walls being provided for inserting said wheel, a horizontal wall extending above said space and connecting said two walls.

8. Theft-prevention device according to claim 1, wherein the means for accommodating the wheel is comprised of two substantially vertical and parallel walls, a space between the walls being provided for inserting said wheel, and at least part of said walls being mobile in displacement, to come nearer or to separate, so as to adapt width of said space to thickness of said wheel.

9. Theft-prevention device according to claim 1, wherein the means for seizing through hooking-in is comprised of a chuck jaw, two jaws being closed around a rim of the wheel.

10. Theft-prevention device according to claim 1, wherein the means for seizing through hooking-in is comprised of a hook, being unfolded in order to pass through the wheel, preferably between elements of the frame.
